(19) United States
(12) Patent Application Publication
(10) Pub. No.: US 2026/0200101 A1
(43) Pub. Date: Jul. 16, 2026

(54) NON-LIFTING END EFFECTOR

(71) Applicant: JBT Marel Corporation, Chicago, IL (US)

(72) Inventors: Kaleb A. Willis, Everett, WA (US); Jonathan James Keogh, Snoqualmie, WA (US); Wade Bennett VanWinkle, Snohomish, WA (US)

(73) Assignee: JBT Marel Corporation, Chicago, IL (US)

(21) Appl. No.: 19/443,309

(22) Filed: Jan. 8, 2026

Related U.S. Application Data
(60) Provisional application No. 63/744,072, filed on Jan. 10, 2025.

(51) Int. Cl. B25J 15/00

(52) U.S. Cl. CPC B25J 15/0028

(57) ABSTRACT

An end effector for a workpiece organization assembly may include a gripping member assembly having a gripping member configured to compliantly engage a workpiece, a biasing assembly configured to resiliently urge the gripping member into engagement with a workpiece, a friction assembly configured to define a friction interface between the gripping member and a workpiece such that when a downward force is applied to the gripping member, the gripping member may be moved at least one of horizontally and rotationally to adjust at least one of a location and orientation of the workpiece on a surface without lifting the workpiece, and a base mounting assembly configured to secure the end effector to a workpiece organizing component configured to move in multiple directions.

### CROSS-REFERENCE TO RELATED APPLICATION

This application claims the benefit of U.S. Provisional Application No. 63/744072, filed Jan. 10, 2025, the entire contents of which are incorporated herein by reference.

### BACKGROUND

An end effector may be the device at the end of a robotic or actuator arm, designed to interact with the environment, and/or may be the last link (or endpoint) of the robot/actuator. At an endpoint, tools may be attached; or, the end effector may itself act as a tool. An end effector may include one or both of a gripper or a tool. While grippers tend to hold, lift, transport and/or manipulate objects, tool functions often have a contrasting function, and may change a characteristic of the work object rather than gripping or holding it. Tool functions may include welding or fusing, spraying, dispensing, milling, screw or nut driving, flattening, cutting, and combinations of these.

At least four categories of end effector include impactive (e.g., jaws, claws, grasping a work object by direct impact, including holding friction); ingressive (e.g., penetrating the work object with needles, pins, or hackles); astrictive (e.g., essentially attractive or field forces such as Bernouilli lift, suction force, vacuum force, magnetic, electrostatic, van der Waals', ultrasonic standing waves, laser tweezing), and contigutive (e.g., essentially adhesive forces via capillary action, glue, surface tension, freezing, chemical reaction).

Systems and methods disclosed herein relate to an end effector for use in organizing workpieces or the like.

### SUMMARY

In some aspects, the techniques described herein relate to an end effector for a workpiece organization assembly, including: a gripping member assembly having a gripping member configured to compliantly engage a workpiece; a biasing assembly configured to resiliently urge the gripping member into engagement with a workpiece; a friction assembly configured to define a friction interface between the gripping member and a workpiece such that when a downward force is applied to the gripping member, the gripping member may be moved at least one of horizontally and rotationally to adjust at least one of a location and orientation of the workpiece on a surface without lifting the workpiece; and a base mounting assembly configured to secure the end effector to a workpiece organizing component configured to move in multiple directions.

In some aspects, the techniques described herein relate to an automated infeed system, including: a primary organization assembly configured to perform a primary workpiece organization to an aggregated supply of workpieces; an organization assessment assembly having at least one sensor configured to capture sensor data regarding the primary workpiece organization; and a secondary organization assembly configured to perform a secondary workpiece organization based on the sensor data regarding the primary workpiece organization, the secondary organization assembly including: a workpiece organization component assembly configured for adjusting a position of a workpiece, the workpiece organization component assembly including: at least one workpiece organizing component configured to move in multiple directions; an end effector moveable by the at least one workpiece organizing component and configured to engage and slide a workpiece along a surface of a movement assembly without lifting the workpiece; and a workpiece organization component controller configured for controlling movement of the workpiece organization component assembly.

In some aspects, the techniques described herein relate to a method of organizing workpieces, including: moving an end effector of a workpiece organizing component to a workpiece-engaging position substantially vertically above a workpiece; moving the end effector downwardly into engagement with the workpiece to define a frictional interference between the workpiece and a gripping member of the end effector; resiliently biasing the gripping member into engagement with the workpiece; and moving the end effector at least one of horizontally and rotationally to adjust at least one of a location and orientation of the workpiece on a surface without lifting the workpiece.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a block diagram of a non-limiting example of an automated line loading management system according to various aspects of the present disclosure.

FIG. 2 shows a side view of an exemplary automated line loading management system according to various aspects of the present disclosure.

FIG. 3 shows a top view of the exemplary automated line loading management system of FIG. 2.

FIG. 4 shows a block diagram of a non-limiting example of a secondary organization assembly according to various aspects of the present disclosure.

FIG. 5 shows a first isometric view of portions of an exemplary automated infeed system according to various aspects of the present disclosure.

FIG. 6 shows a second isometric view of the exemplary automated infeed system of FIG. 4.

FIG. 7 shows a bottom isometric view of an end effector according to an example of the present disclosure.

FIG. 8 shows a top isometric view of the end effector of FIG. 7.

FIG. 9 shows a bottom isometric view of the end effector of FIG. 7, wherein a portion of a gripping member of the end effector is depressed.

FIG. 10 shows a bottom isometric view of the end effector of FIG. 7, wherein a portion of a gripping member of the end effector is engaged with a workpiece.

FIG. 11 shows a side view of the end effector of FIG. 7, wherein a portion of a gripping member of the end effector is engaged with a workpiece.

FIG. 12 shows an isometric environmental view of an end effector according to an example of the present disclosure.

FIG. 13 shows a top isometric view of the end effector of FIG. 12.

FIG. 14 shows a first side isometric view of the end effector of FIG. 12, wherein a gripping member assembly of the end effector is engaged with a workpiece.

FIG. 15 shows a second side isometric view of the end effector of FIG. 12, wherein a gripping member assembly of the end effector is engaged with a workpiece.

FIG. 16 shows a third side isometric view of the end effector of FIG. 12.

FIG. 17 shows a first bottom isometric view of the end effector of FIG. 12.

FIG. 18 shows a second bottom isometric view of the end effector of FIG. 12.

FIG. 19 shows a third bottom isometric view of a portion of the end effector of FIG. 12.

FIG. 20 is a block diagram that illustrates a non-limiting example of a computing device appropriate for use as a computing device with examples of the present disclosure.

### DETAILED DESCRIPTION

Workpiece processing machines are typically fed an aggregated or bulk amount of workpieces on an incoming conveyance system that must be spread out, oriented, arranged or otherwise organized in order to be optimally processed by the machine. With regard to industrial food processing machines, such as portioners, injectors, ovens, freezers, breaders, fryers, packagers, etc., the incoming bulk supply of food products are typically deposited from a large tote (e.g., a 1,000 or 2,000 pound tote) into a hopper system, which then deposits the products onto an infeed conveyance system. The hopper system may be capable of providing an initial spreading of the food products as they are deposited onto the infeed conveyance system, but the food products are still often overlapping, doubled-up, stacked, spaced inappropriately, or incorrectly oriented (such as being head first v. tail first, skin side up v. down, on its side v. on a top or bottom, etc.).

Industrial food processing machines typically have threshold requirements for product arrangement and spacing to optimally process those products. For instance, a high-speed portioning machine, which may be used to portion, trim, or otherwise cut a food product into smaller pieces in accordance with customer needs, must have the food products sufficiently spread out on the conveyor belt without overlapping or doubled-up product. Although these machines use various scanning and data processing techniques to ascertain parameters of the incoming food product to determine how to most efficiently cut the food product, cutting can be further optimized by optimally organizing, arranging or orienting the food products (such as being head first v. tail first, skin side up v. down, etc.). Further, although sufficient spacing between food products is needed, through-put can be optimized if the spacing is minimized (the “belt loading density”). Similar requirements exist for other food processing machines, such as injectors, ovens, freezers, breaders, fryers, etc.

In most instances, the incoming, bulk supply of product is arranged manually by workers standing next to the infeed conveyance system. The workers can spread, remove doubled-up or stacked product, orient, and arrange the products according to machine and/or customer specifications. Many workers can fit into a small length of the infeed conveyance system (e.g., 800 mm of belt length) to arrange a significant supply of incoming bulk product. However, manual labor is costly and unreliable.

Efforts have been made to replace manual labor with automated systems, such as robotic systems. An example of such an automated line loading management system is shown and described in U.S. Patent Application Publication No. US2025/0304381A1, entitled “AGGREGATED TO ORGANIZED AUTOMATED LINE LOADING SYSTEM AND METHOD”, the entire contents of which are expressly incorporated herein.

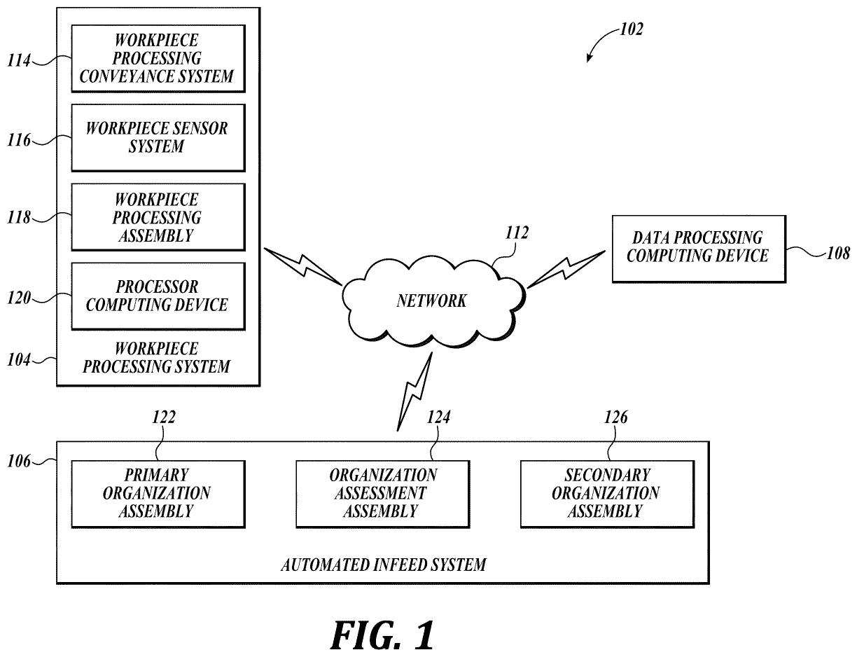

FIG. 1 shows a block diagram of the non-limiting example of an automated line loading management system 102 shown and described in U.S. Patent Application Publication No. US2025/0304381A1, incorporated herein. The automated line loading management system 102 can be used to manage an automatic transition of an incoming, aggregated supply of workpieces into a substantially continuous, organized flow of workpieces for delivery to an infeed of a processing machine. The automated line loading management system 102 may include various components and networked computing devices configured for managing aspects of automatically transitioning an incoming, aggregated supply of workpieces into a substantially continuous, organized flow.

Although the automated line loading management system 102 will not be described in detail, in the depicted example, the automated line loading management system 102 generally includes a workpiece processing system 104, an automated infeed system 106, and a data processing computing device 108 communicatively coupled together through a network 112. The network 112 can be any kind of network capable of enabling communication between the various components of the automated line loading system 102. For example, the network can be a WiFi network.

Exemplary aspects of the workpiece processing system 104 will first be described. The processing system 104 is generally configured to carry out processing of workpieces after the workpieces have been organized and/or transitioned from an aggregated supply into a continuous flow by the automated line loading management system 102. In that regard, the workpiece processing system 104 includes a workpiece processing conveyance system 114 or another movement device configured to carry workpieces between various portions of the processing system. For instance, the workpiece processing conveyance system 114 may carry workpieces from an infeed end, where the workpiece processing system 104 receives workpieces from the automated line loading management system 102, toward an outfeed end. Along the way, the workpiece processing conveyance system 114 may carry workpieces past a workpiece sensor system 116, where one or more sensors may be used to gather data regarding the workpieces. For instance, the workpiece sensor system 116 may include a scanner station, a weight measurement station, a temperature station, etc., configured to capture image data, weight data, and temperature data, respectively, of the workpieces, etc. The sensor data may be processed by the processor computing device 120 and/or the data processing computing device 108.

The workpiece processing conveyance system 114 may also carry workpieces to various components of a workpiece processing assembly 118, which may be configured to carry out one or more processing operations on the workpiece. In an example of a portioner, the components may include one or more of a slicer, a cutter station, a pick-up station, a sorter, and a packager. In an example of an oven, the components may include one or more of an air circulation assembly, a spiral belt assembly, a moisture control assembly, etc. The components of the workpiece processing assembly 118 may be controlled by a processor computing device 120 (such as in response to input of the data processing computing device 108).

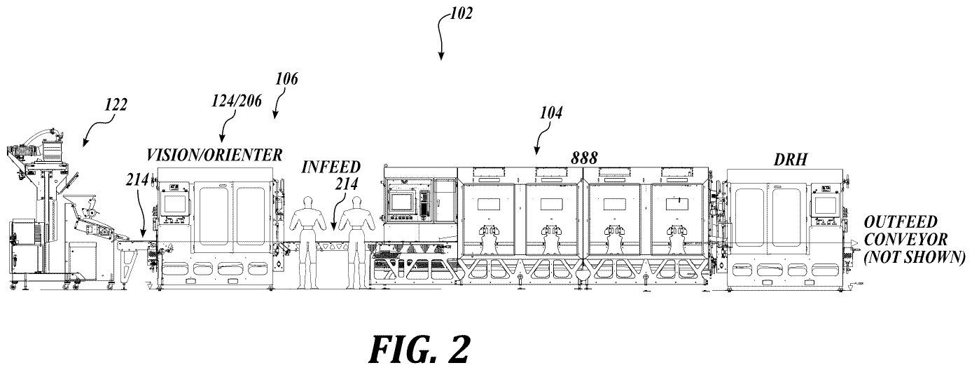

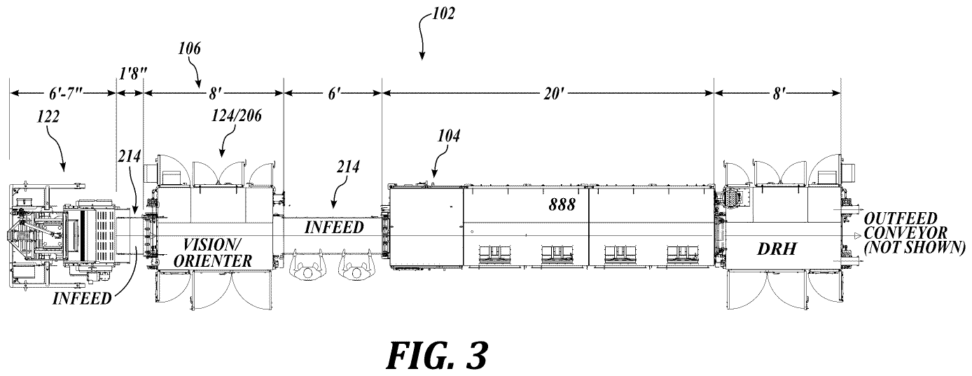

Of course, any other suitable workpiece processing system having other suitable components may instead be used. For instance, the processing system 104 may incorporate aspects of a portioner system, such as those shown and described in U.S. Pat. No. 7,651,388, entitled “Portioning apparatus and method”, U.S. Pat. No. 7,672,752, entitled “Sorting workpieces to be portioned into various end products to optimally meet overall production goals”, and U.S. Pat. No. 8,688,267, entitled “Classifying workpieces to be portioned into various end products to optimally meet overall production goals”, hereby incorporated by reference herein in their entirety (see also FIGS. 2 and 3). The processing system 104 may incorporate aspects of the thermal processing systems, such as those shown and described in U.S. Patent App. Pub. No. US20070131215A1, entitled “Continuous cooking oven system”, U.S. Patent App. Pub. No. US20180213801A1, entitled “Spiral conveyor thermal processing system”, and U.S. Pat. No. 10,912,317B2, entitled “Thermal processing apparatus.”

Exemplary aspects of the automated infeed system 106 will now be described. The automated infeed system 106 is generally configured to receive an incoming, unorganized supply of workpieces and transition the supply into a substantially organized flow of workpieces. It should be appreciated that the term “organization” may be used to reference any change in a workpiece(s) position, orientation, spacing, arrangement, etc., to support infeed workpiece machine processing needs. If the incoming supply of workpieces is presented in an aggregated format, such as in bulk and/or batch format, the automated infeed system 106 may also be configured to transition the supply into a substantially continuous flow of workpieces.

In the depicted example, the automated infeed system 106 includes a primary organization assembly 122 configured to carry out an initial or primary organization of unorganized, aggregated workpieces, an organization assessment assembly 124 configured to assess the quality of the initial organization, a secondary organization assembly 126 configured to carry out a second, more precise organization of the workpieces, and a workpiece processing system 104 generally configured to carry out processing of workpieces after the workpieces have been organized and/or transitioned from an aggregated supply into a continuous flow by the automated line loading management system 102.

FIGS. 2 and 3 depict views of an exemplary automated line loading management system 102 in accordance with examples of the present disclosure. In the depicted exemplary automated line loading management system 102, the primary organization assembly 122, which is configured to carry out an initial or primary organization of unorganized, aggregated workpieces, includes a C.A.T. VacCAT Product Distribution System™, available from JBT Corporation of Chicago, IL, also shown and described in U.S. Pat. No. 7,541,549, incorporated in its entirety herein. A tote dumper, vacuum system, or other workpiece supply assembly is not shown.

The organization assessment assembly 124, which is configured to assess the quality of the initial organization, may include a sensor assembly, such as a vision system for capturing image sensor data of the workpieces, etc. The vision system and any other sensors may be enclosed in a housing together with the secondary organization assembly 126. The sensor data may be processed by a suitable controller or computing device in communication with the organization assessment assembly 124 and communicate with the secondary organization assembly 126 for carrying out a second, more precise organization of the workpieces. The organized workpieces may then be conveyed to the workpiece processing system 104 for carrying out any workpiece processing, such as cutting (e.g., portioning, slicing, trimming, etc.), marinating (e.g., injecting), thermal processing (e.g., cooking, freezing, etc.), etc.

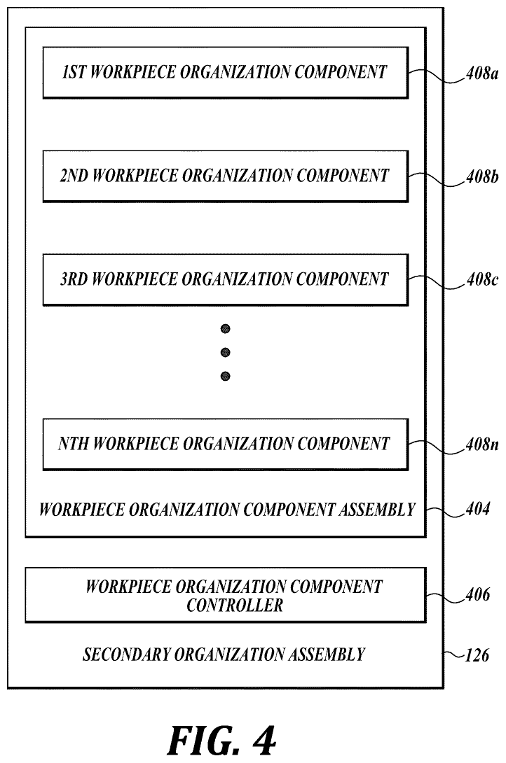

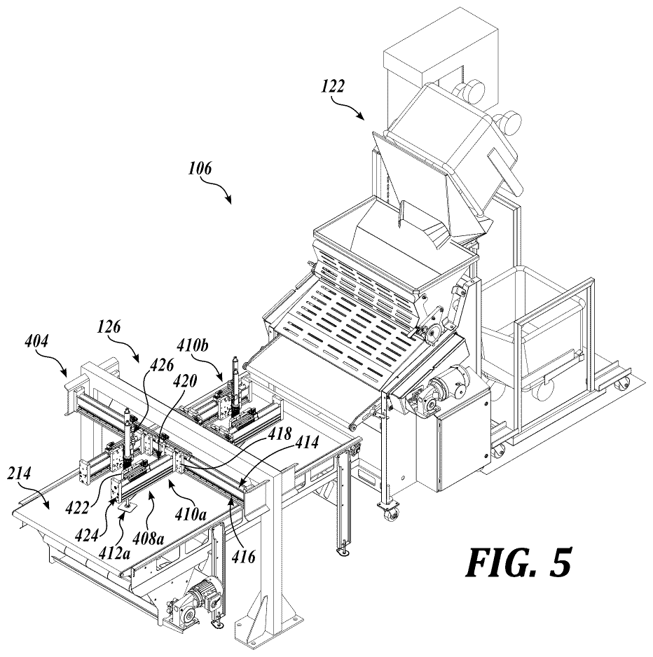

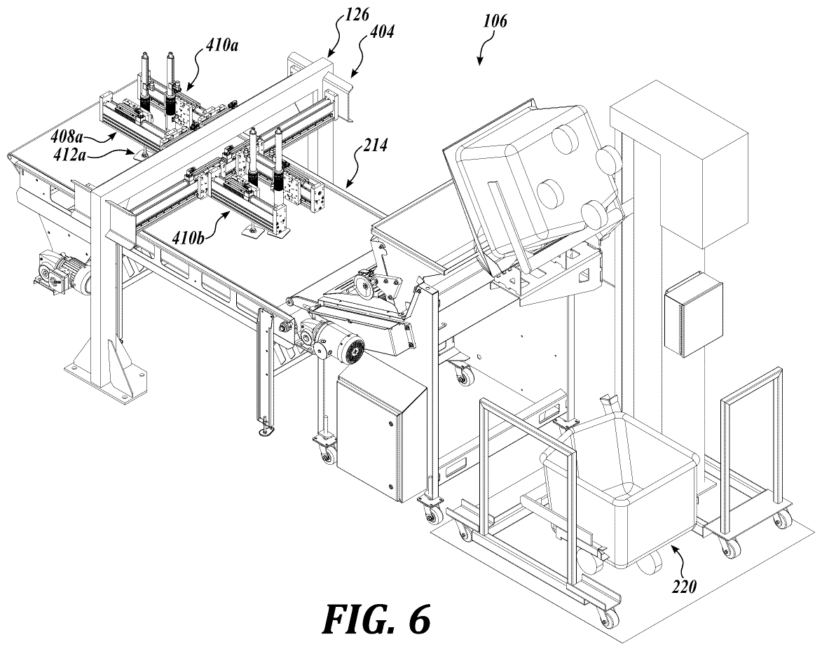

Exemplary aspects of the secondary organization assembly 126 will now be described with reference to the exemplary block diagram shown in FIG. 4 and the exemplary systems shown in FIGS. 5 and 6, wherein like components include the same reference number. Generally, the secondary organization assembly 126 includes a workpiece organization component assembly 404 having organization components for carrying out a second, more precise organization of workpieces and a workpiece organization component controller 406 configured for controlling aspects of the workpiece organization component assembly 404.

The workpiece organization component assembly 404 includes one or more organizing components for adjusting a position of a workpiece(s) on the workpiece flow conveyance assembly 214, such as by moving a workpiece to a different location on the conveyor, changing an orientation of a workpiece, rearranging a workpiece, etc. The one or more organizing components can adjust a position of a workpiece(s) in a high-quality manner as is typically done with manual labor, yet without increasing the overall footprint of an infeed system.

The workpiece organization component assembly 404 may include any type and number of organization components suitable for the intended application. For instance, the workpiece organization component assembly 404 may include first, second, third, and nth workpiece organizing components 408a, 408b, 408c, and 408d, respectively (hereinafter sometimes simply referred to as a “workpiece organizing component 408” or “workpiece organizing components 408”). The type and number of workpiece organization components used may depend, for instance, on the type of workpieces being organized, the organization specifications of a corresponding workpiece processing machine, a size of the workpiece flow conveyance assembly 214, a quantity of workpieces being moved by the workpiece flow conveyance assembly 214, etc.

In the exemplary secondary organization assembly 126 shown in the exemplary automated infeed system 106 of FIGS. 5 and 6 (wherein the organization assessment assembly 124 is not shown), the workpiece organization component assembly 404 is configured as at least one ultra-compact (densely arranged), purpose built, prime mover array having end effectors. For instance, each of the workpiece organizing components 408 may be configured as prime movers (hereinafter “prime mover 408”) each with an end effector 412 in an array(s), wherein the prime movers 408 work in coordination to further organize the workpieces. Each prime mover 408 with end effector 412 may be substantially identical; and therefore, only a first prime mover 408a having a first end effector 412a will be described in detail.

A first array 410a may include the first prime mover 408a configured to move in multiple directions to position the first end effector 412a for engagement with a workpiece(s). In some examples, the first prime mover 408a is a linear actuator system having linear actuator assemblies configured to move the first end effector 412a in at least x- y-, z-, and theta axis directions. For instance, the first prime mover 408a may include a first linear actuator assembly 414 having a first linear movement axis extending along a support beam 416 positioned above and extending substantially transversely across a width of the workpiece flow conveyance assembly 214. For instance, first and second ends of the support beam 416 may be secured to brackets (not labeled) extending upwardly from a frame of the workpiece flow conveyance assembly 214 to suitably position the support beam above the conveyor.

The first linear actuator assembly 414 has a first linear motor configured to move a first load plate 418 a length of the support beam 416 along the first linear movement axis, such as along a linear guide defined on or otherwise secured to the support beam. The first load plate 418 carries a second linear actuator assembly 420 having a second linear movement axis transversely oriented relative to the first linear movement axis of the first linear actuator assembly 414. The second linear actuator assembly 420 has a second linear motor configured to move a second load plate 422 a length of a cross beam 424 (such as on a linear guide) extending substantially transversely from the first load plate 418 (and substantially transversely from the first linear movement axis).

The second load plate 422 carries a third linear actuator assembly 426 having a third linear movement axis transversely oriented relative to the first and second linear movement axes of the first and second linear actuator assemblies 414 and 420. The third linear actuator assembly 426 has a third linear motor configured to move the first end effector 412 linearly along the third linear movement axis. The third linear actuator assembly 426 may also include a rotary motor for rotating the first end effector 412 about the third linear movement axis. In that regard, the third linear actuator assembly 426 may be considered a linear rotary actuator assembly.

As can be appreciated, the first, second, and third linear actuator assemblies 414, 420, and 426 of the first prime mover 408a enable movement of the first end effector 412 about an x-, y-, and z-axis, as well as a theta axis (with the x-, y-, and z-axis corresponding to the first, second, third linear movement axes, respectively). In that regard, the first end effector 412a may be moved into a position for engaging any workpiece that is within the range of the first prime mover 408a. More specifically, the first end effector 412a may be moved along an x-, y-, and z-axis relative to a conveyor belt of the workpiece flow conveyance assembly 214 along a distance at least as long as a stroke length of the corresponding linear motor. In that regard, in some examples, it may be beneficial to use two or more prime movers in an array to ensure all the workpieces can be reached for a certain belt width within a certain amount of time.

For instance, the first array 410a of the workpiece organization component assembly 404 may also include second, third, and fourth prime movers 408b, 408c, and 408d, as shown in FIG. 5. In the depicted example, each of the second, third, and fourth prime movers 408b, 408c, and 408d, which are substantially identical to the first prime mover 408a as noted above, may have a first linear actuator assembly 414 mounted to the support beam 416. In that manner, each of the second, third, and fourth prime movers 408b, 408c, and 408d may be moveable along the same, first linear movement axis. However, the first, second, third, and fourth prime movers 408b, 408c, and 408d are spaced along the length of the support beam 416 so that each prime mover can reach a different section of the workpiece flow conveyance assembly 214 conveyor belt across its width.

In some examples, the workpiece organization component assembly 404 may further include a second array 410b that may be substantially identical to the first array 410a. The second array 410b may be spaced from the first array 410a along a length of the conveyor belt of the workpiece flow conveyance assembly 214 to increase an organization capacity of the secondary organization assembly 126. In other words, the second array 410b, positioned from the first array 410a along a length of the conveyor belt, can reach workpieces further along the second linear movement axes.

In the depicted example, the second linear movement axis of each prime mover is substantially parallel to a longitudinal axis of the conveyor belt. In that regard, using multiple arrays along a length of the conveyor belt allows for increased organization capacity of the secondary organization assembly 126. It should be appreciated that any suitable combination of prime mover arrays may be used for the intended application. Moreover, any suitable linear and rotary actuators may be used to accommodate the intended application. For instance, in some examples, the linear and rotary actuators may use linear and rotary motors available from LinMot® or another suitable source. A linear motor can achieve high precision, fast movement with an extremely small footprint. In some examples, pneumatic linear and rotary actuators may be used, and/or a combination of electric and pneumatic linear and rotary actuators may be used.

In some examples, the workpiece organizing components 408 may be configured as industrial robots. Such a configuration may be suitable for a workpiece processing line that has a lower density of workpieces to be organized, such as for a high-speed portioner or for more durable workpieces that would not be damaged by robots. In any event, a single industrial robot may consume the same space (belt length) as one of the prime mover arrays that can support multiple prime movers. Accordingly, industrial robots may be more suitable for applications that are not restricted by floor space or belt length.

As noted above, an end effector 412 is configured for engagement with a workpiece(s) when moved into a suitable position by the corresponding prime mover 408. In that regard, and with reference to the first prime mover 408a, the first end effector 412a may be on a distal end of the third linear (rotary) actuator assembly 426 for engaging a workpiece when moved into an appropriate position.

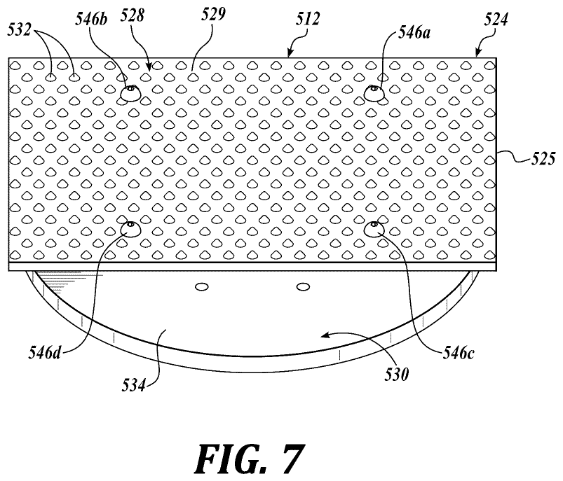

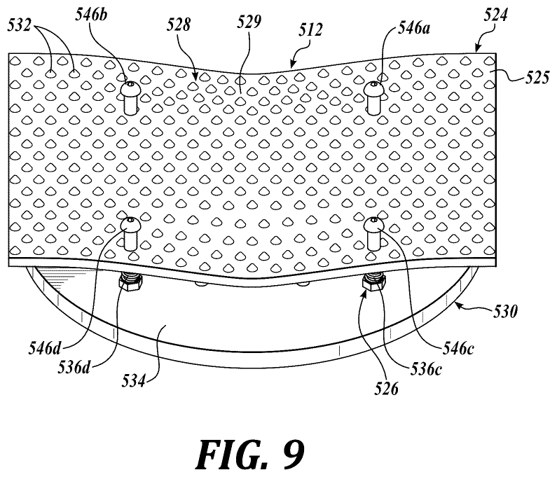

An example of an end effector 512 that may be used with the automated line loading system and method described herein, or other suitable applications, will now be described with reference to FIGS. 7-10. The exemplary end effector 512 depicted in FIGS. 7-11 is configured to move a workpiece WP to a desired location and/or orientation on a conveying surface 520 of a conveyor 522 in a gentle manner without substantially lifting the workpiece. As will be described in more detail below, the end effector 512 is configured to resiliently, compliantly, and frictionally engage with a workpiece WP, wherein frictional forces between the end effector 512 and the workpiece WP are sufficient to overcome frictional forces between the conveying surface 520 and the workpiece WP. In that manner, the end effector 512 can facilitate movement of the workpiece WP along the conveying surface 520 without the need to lift the workpiece WP.

In the depicted example, the end effector 512 includes a gripping member assembly having a gripping member 524 configured to compliantly and frictionally engage a workpiece WP, a biasing assembly 526 configured to support resilient and frictional engagement of the gripping member 524 with the workpiece WP, and a base mounting assembly 530 configured to oppose a biasing force of the end effector 512 and configured to secure the end effector to a workpiece organizing component for being moved relative to the conveying surface 520. As will become appreciated, aspects of the gripping member 524 and biasing assembly 526 define a friction assembly configured to define a friction interface between the gripping member and a workpiece such that when a downward force is applied to the gripping member 524, the gripping member may be moved at least one of horizontally and rotationally to adjust at least one of a location and orientation of the workpiece on a surface without substantially lifting the workpiece.

Exemplary aspects of the gripping member 524 will now be described. As noted above, the gripping member 524 is configured to resiliently, compliantly, and frictionally engage a workpiece WP. Referring to FIG. 7, the gripping member 524 includes a body 525 having a size, shape, and composition suitable to support a frictional, resilient, and an at least somewhat shape-conforming engagement with at least a portion of an outer surface of a workpiece. Although the gripping member 524 may be any suitable configuration, in the depicted example, the body 525 of the gripping member 524 is configured as a substantially flat, thin, rectangular sheet. In some examples, the overall shape or outline of the body 525 of the gripping member 524 may be configured to substantially match the overall shape or outline of the workpieces to be moved. For example, if the gripping member 524 was configured for use with poultry tenders, the body 525 of the gripping member 524 may have a more elongated, skinnier shape to better match a long and slender shape of the tenders.

The body 525 of the gripping member 524 includes an outer contact surface 528 configured to frictionally engage the workpiece WP. In the depicted example, the contact surface 528 is defined by a generally flat, planar surface 529 (when the gripping member 524 is flattened) covered with friction-enhancing elements, such as a plurality of substantially uniformly distributed protrusions 532. The protrusions 532 are configured to frictionally engage with the workpiece WP and increase the overall frictional forces between the workpiece WP and the contact surface 528.

In that regard, the protrusions 532 have an individual size and shape configured to collectively help define a frictional interference between the gripping member and the workpiece. The frictional interference is sufficient to enable the end effector 512 to adjust at least one of a location and orientation of the workpiece on the surface without substantially lifting the workpiece. “Without substantially lifting the workpiece” can be generally understood to mean that the end effector does not pick up and move the workpiece or significantly lift the workpiece off the conveyor surface.

In the example shown, the protrusions 532 are dome-shaped or at least somewhat rounded in overall shape to facilitate gripping against the outer surface of the workpiece WP without piercing or otherwise damaging the workpiece WP. In other examples, where a greater frictional force between the contact surface 528 and the workpiece WP is needed, and/or where surface damage to the workpiece WP is not an issue, the raised protrusions 532 may be configured as sharper, more pointed protrusions. In some examples, the friction-enhancing elements may be defined by other types of features, such as a plurality of recesses, holes, or the like defined in the body 525.

In any event, the protrusions 532 or other friction-enhancing elements are configured to help overcome frictional forces between the conveying surface 520 and the workpiece WP to move the workpiece relative to the conveying surface 520 without substantially lifting the workpiece. The downward force of the workpiece organizing component causes the protrusions 532 to frictionally engage the workpiece. In that regard, a sufficient downward force is applied to the workpiece WP via the workpiece organizing component to cause the protrusions 532 to meet at least minimum frictional load requirements for moving the workpiece. The downward force of the workpiece organizing component may be controllable or otherwise limited (e.g., the workpiece organizing component is only moved downwardly to a certain height relative to the conveying surface 520) to substantially prevent damage to the workpiece WP, flattening of the workpiece WP, etc.

The gripping member 524 may be made of a compliant material such that it may at least somewhat conform to at least a portion of the outer profile or shape of the workpiece. In some examples, the gripping member 524 may be made of an elastomer. In one example, the gripping member 524 is made from a material like that of a compliant, endless conveyor belt. A compliant material can support resilient gripping member engagement with a workpiece, such as through the biasing force of the biasing assembly 526. In some examples, the gripping member 524 is itself made of a resilient material. In any event, the material of the gripping member 524 is preferably a food-grade material suitable for withstanding industrial cleaning methods for workpiece (e.g., food) processing.

In the examples described herein, the contact surface 528 is further configured to prevent adherence to the workpiece WP once the workpiece WP has been arranged in a preferred location, orientation, etc. In other words, after the workpiece WP has been moved to its preferred location, orientation, etc., the end effector 512 can be disengaged from the workpiece and moved upwardly toward a retracted position without substantially affecting the workpiece location, orientation, etc. In that regard, the raised protrusions 532 are sufficiently shaped and sized to substantially avoid piercing the workpiece WP, which might otherwise cause substantial lifting of the workpiece WP off the conveying surface 520 when the end effector 512 is retracted. Further, the material of the gripping member 524 may be selected to substantially prevent an adhesive effect between the contact surface 528 and the workpiece WP. Thus, as can be appreciated, movement of the workpiece WP relative to the conveying surface 520 can be achieved with substantially no lifting of the workpiece WP.

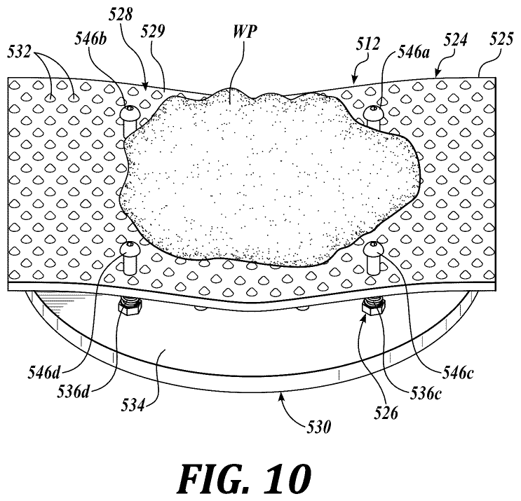

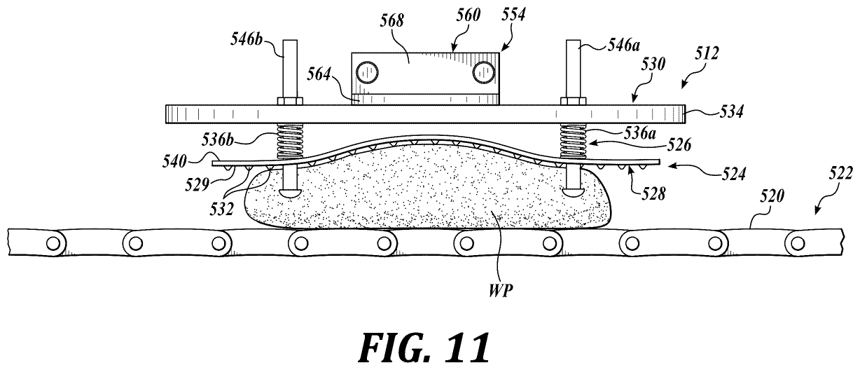

Referring to FIGS. 10 and 11, the biasing assembly 526 configured to resiliently urge portions of the gripping member 524 into engagement with the workpiece WP will now be described. The biasing assembly 526 generally includes at least one biasing member disposed between the gripping member 524 and a portion of the base mounting assembly 530. In the depicted example, the biasing assembly 526 includes a plurality of compression springs 536 extending between an inner surface 540 of the gripping member 524 and a base plate 534 of the base mounting assembly 530.

The compression springs 536 may be coaxially secured on corresponding connecting elements that extend between and space apart the gripping member 524 and a base plate 534 of the base mounting assembly 530. In the depicted example, each connecting element is a bolt 546 extending through and connecting the gripping member 524 and the base plate 534 in a spaced, substantially parallel relationship. A plurality of bolts 546 and compression springs 536 may be arranged around a perimeter of the gripping member 524 to support conformance of the gripping member 524 with the workpiece WP.

In the depicted example, first, second, third and fourth bolts 546a, 546b, 546c, and 546d and corresponding first, second, third and fourth compression springs 536a, 536b, 536c, and 536d are arranged generally around a perimeter of the workpiece outline (wherein only the first and second compression springs 536a 536b are shown). For ease of reference, the first, second, third and fourth bolts 546a, 546b, 546c, and 546d may be sometimes simply referred to as “compression springs 536”, and the first, second, third and fourth bolts 546a, 546b, 546c, and 546d may be sometimes simply referred to as “bolts 546”.

It should be appreciated that fewer or more bolts/compression springs may be used depending on the workpiece WP shape and size, the workpiece WP organizing requirements, etc. In the depicted example, the workpiece WP is generally dome shaped, representative of a chicken breast fillet or similar. It should be noted that the location of the bolts/compression springs relative to the resilient gripping member 524 may be modified to accommodate various other workpiece sizes, shapes, etc. For example, if the workpiece has edge portions that are taller than a middle portion, the bolts/compression springs may instead be located nearer a middle portion of the resilient gripping member 524. In that manner, the bolts/compression springs can depress a middle portion of the resilient gripping member 524 into engagement with the workpiece WP to substantially match a shape profile of the workpiece. Thus, it should be appreciated that the configuration shown in the FIGS. is exemplary only, and the configuration may be modified to accommodate other workpiece sizes, shapes, etc.

The biasing force of the compression springs 536 resiliently urges portions of the gripping member 524 into engagement with the workpiece WP when a downward force is supplied by the workpiece organizing component (e.g., a prime mover, such as prime mover 408). Upon engagement with the workpiece WP, the gripping member 524 moves upwards towards the base plate 534, compressing the springs 536. At the same time, the biasing force of the compressed springs 536 resiliently urges corresponding portions of the gripping member 524 at the locations of the bolts/compression springs toward the workpiece WP. As such, outer portions of the gripping member 524, as generally defined around the perimeter of the workpiece WP at the locations of the bolts/compression springs, substantially conform to outer portions of the workpiece. In effect, the gripping member 524 substantially conforms to the dome-like curvature of the workpiece WP, as shown in FIG. 11. By substantially enveloping the workpiece WP in this manner, the contact surface area of the gripping member 524 with the workpiece WP, and thus, the frictional interface therebetween can be maximized. Maximizing the frictional interface helps facilitate optimized manipulation of the workpiece WP into the preferred location and/or orientation on the conveying surface 520.

With the gripping member 524 resiliently, compliantly, and frictionally engaged with a workpiece WP, as described above, the end effector 512 may be manipulated by the workpiece organizing component (e.g. a prime mover such as prime mover 408) to move the workpiece WP into a preferred location, orientation, etc. For instance, after a sufficient downward force has been applied to the end effector 512 by a prime mover, a rotational force may be applied to the end effector 512 to manipulate the orientation of the workpiece WP to a preferred orientation. In addition, or in the alternative, a lateral or horizontal force may be applied to the end effector 512 to move the workpiece WP laterally/horizontally to a preferred location on the conveying surface 520.

Rotational movement may include movement of the workpiece WP generally clockwise and/or counterclockwise to a preferred degree of rotation (e.g., 0-360°). Lateral or horizontal movement may include movement of the workpiece WP generally upstream or downstream of the conveyor, diagonally upstream or downstream of the conveyor, laterally across the conveyor, or the like.

After the workpiece WP has been moved to its preferred location, orientation, etc., the end effector 512 is moved upwardly toward a retracted position by the prime mover to disengage the workpiece. Upon disengaging the workpiece WP, the compression springs 536 extend, urging the gripping member 524 back towards the original, substantially flat shape it possessed prior to deformation (see FIG. 7). In that regard, the gripping member 524, having a compliant body 525, may be considered a compliant assembly as it may return to its original, non-workpiece-conforming shape. In some examples, the body 525 may be configured as a resilient assembly to help or otherwise define the biasing force of the gripping member 524.

With the gripping member 524 substantially back to its original form, the end effector 512 is ready for engagement with and substantial shape conformance with another workpiece. In that regard, the resilient and compliant gripping member 524 is configured for individualized, repeated frictional engagement with workpieces WP moving along the conveying surface 520.

Exemplary aspects of the base mounting assembly 530 will now be described. As noted above, the base mounting assembly 530 is configured to support a biasing force of the end effector 512 and secure the end effector to a workpiece organizing component (e.g., a prime mover, such as prime mover 408). The base mounting assembly 530 generally includes the base plate 534 configured to oppose the biasing force of the biasing assembly 526 and a workpiece organizing component mounting assembly 554 for securing the base plate 534 to a workpiece organizing component.

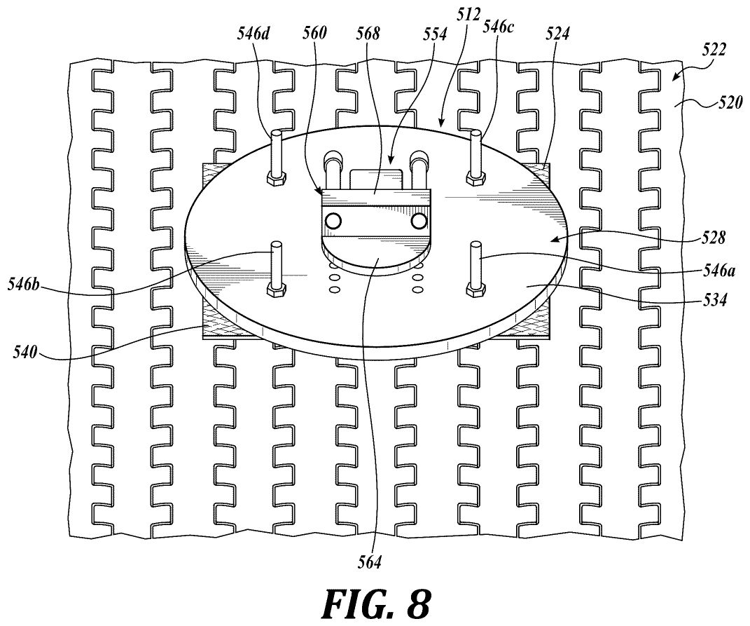

Referring to FIG. 8, the base plate 534 is a rigid member that can oppose the biasing force of the compression springs 536 and that can provide a structure against which the prime mover may be mounted. The base plate 534 may be any suitable configuration. For instance, the base plate 534 may be similar in overall shape and size to the gripping member 524. Although the base plate 534 is shown as having a circular outline in the depicted example, it may instead be rectangular in shape like the gripping member 524. In any event, the base plate 534 may be configured as a substantially flat, thin, rigid member.

In some examples, the base plate 534 may be configured to accommodate various sizes and shapes of workpieces. For instance, the base plate 534 may be larger in size than the gripping member 524 such that the bolts 546 and corresponding compression springs 536 can be optimally positioned around a perimeter of the required gripping member. With the bolts 546 and corresponding compression springs 536 optimally positioned around a perimeter of the required gripping member, shape conformance of the gripping member to the workpiece can be optimized. The base plate 534 may also be of a suitable size and/or shape to substantially prevent interference with other nearby end effectors that are simultaneously moving workpieces on the conveyor surface. For instance, a circular outline, as shown, may minimize end effector interference.

As noted above, the compression springs 536 may be coaxially secured on corresponding bolts 546 that extend between and space apart the gripping member 524 and the base plate 534. In that regard, the gripping member 524 and base plate 534 are configured with a plurality of substantially aligned holes equal in number to the number of bolts 546. The holes in the base plate 534 may be substantially the same diameter as or slightly larger in diameter than a diameter of the bolts 546. In this manner, each hole in the base plate 534 is configured to receive a bolt 546 therethrough, but with minimal clearance to substantially prevent lateral movement.

Similarly, the holes in the gripping member 524 have a diameter that is substantially the same diameter as or slightly larger than the diameter of the bolts 546. In this manner, the gripping member 524 can move along the longitudinal axis of the bolts 546 in response to the biasing force of the compression springs 536. At the same time, the gripping member 524 can at least somewhat conform to the shape of the workpiece WP. Thus, at least some clearance is provided between the diameter of the holes in the gripping member 524 and the bolts 546 to enable such gripping member shape conformance, yet the clearance may be optimized to minimize lateral movement between the gripping member 524 and the bolts 546.

In the depicted example, each bolt 546 extends through and connects the gripping member 524 and the base plate 534 in a spaced, substantially parallel relationship. First and second nuts (not labeled) may be secured on each bolt and disposed on first and second sides of the base plate 534 to secure the base plate 534 in its vertical position on the corresponding bolt. Further, a head of each bolt 546 may be disposed on the outer (contact surface 528) side of the gripping member 524 to retain the gripping member on the bolt between the corresponding compression spring 536 and the base plate 534.

The bolts 546 may each be a suitable length to extend from the first and second sides of the base plate 534 to support the biasing effects of the end effector 512 and adjustability/versatility of the end effector. For instance, as may be best understood by referring to FIG. 11, the bolts 546 may protrude from the first (inner) side of the base plate 534 a sufficient length to receive a compression spring of a certain length/spring force between the base plate and gripping member 524. Further, the bolts 546 may protrude from the second (outer) side of the base plate 534 a sufficient length to allow for adjustability of the base plate position along the bolt (e.g., by moving the position of the nuts). In this manner, the end effector 512 may be adjusted in configuration to accommodate workpieces of different profiles, thickness, etc.

The workpiece organizing component mounting assembly 554 will now be described with reference to FIGS. 8 and 11. The workpiece organizing component mounting assembly 554 may be generally configured as any suitable assembly that facilitates mounting of the base plate 534 to the workpiece organizing component (e.g., a prime mover, such as prime mover 408). In the depicted example, the workpiece organizing component mounting assembly 554 includes an L-shaped connecting bracket 560. A first portion 564 of the connecting bracket 560 is secured to the base plate 534, and a second portion 568 of the connecting bracket 560 that is substantially transverse to the first portion 564 is securable to the prime mover.

The first portion 564 of the connecting bracket 560 may be secured to the base plate 534 in any suitable manner, such as by welding, fasteners, etc. In the depicted example, the first portion 564 of the connecting bracket 560 is adjustably secured to the base plate 534 with one or more fasteners, such as bolts, that are passed through correspondingly alignable openings in the first portion 564 of the connecting bracket 560 and the base plate 534. The base plate 534 may have a plurality of openings defined across its width and/or length such that the first portion 564 of the connecting bracket 560 may be secured to the base plate in a variety of locations, positions, orientations, etc.

Similarly, the second portion 568 of the connecting bracket 560 may be secured to the workpiece organizing component with one or more fasteners, such as bolts, that are passed through correspondingly aligned openings. Although not shown, the second portion 568 of the connecting bracket 560 may likewise include a plurality of openings for adjustable connection between the second portion 568 and the workpiece organizing component (and/or the workpiece organizing component may include a plurality of openings for adjustable connection).

Operation and use of the end effector 512 for moving a workpiece WP into a desired location, orientation, etc., will now be described with reference to FIG. 11. With the end effector 512 in a first position, the end effector 512 may be moved by the workpiece organizing component to a workpiece-engaging position. For instance, the workpiece organizing component may be activated to move the end effector substantially vertically above a selected workpiece. The selected workpiece may need to be adjusted in location and/or orientation on the conveying surface 520. Once located above the workpiece, the workpiece organizing component may continue to move the end effector 512 in the direction of conveyance at substantially the same speed as the conveyor 522, thereby substantially matching the workpiece movement.

With the end effector 512 located generally above the workpiece WP, the workpiece organizing component may be activated to lower the end effector until the gripping member 524 engages the workpiece WP with a suitable downward force. The workpiece WP, held in its vertical location by the conveyor 522, provides a reactive force and urges the gripping member 524 upwardly. At the same time, the compression springs 536 compress and resiliently urge portions of the gripping member 524 into engagement with the workpiece WP. The downward force of the workpiece organizing component may be applied until the gripping member 524 at least somewhat conforms to the shape of the workpiece, as shown in FIG. 11. With the gripping member 524 substantially conforming to the shape of the workpiece and held against the workpiece with the downward force of the workpiece organizing component, a frictional interface is defined between the gripping member 524 and the workpiece WP.

The workpiece organizing component may then be moved relative to the conveyor 522 to adjust the location and/or orientation of the workpiece WP on the conveying surface 520. For instance, a rotational force may be applied to manipulate the orientation of the workpiece WP to a preferred orientation. In addition, or instead, a lateral or horizontal force may be applied to the end effector 512 to move the workpiece WP to a preferred location on the conveying surface 520. The protrusions 532 or other friction-enhancing elements enhance friction between the gripping member contact surface 528 and the workpiece WP as force is applied, thus allowing for greater control when manipulating the workpiece WP on the conveying surface 20 and less slippage between the workpiece WP and the contact surface 528.

Once the desired location and/or orientation has been achieved, the end effector 512 may be disengaged from the workpiece WP and moved upwardly toward a retracted position. As noted above, the end effector 512 may be disengaged from the workpiece WP with minimal adherence such that it does not substantially affect the workpiece location, orientation, etc. Upon retracting, the compression springs 536 extend, and the gripping member 524 substantially returns to its original form, ready for engaging another workpiece.

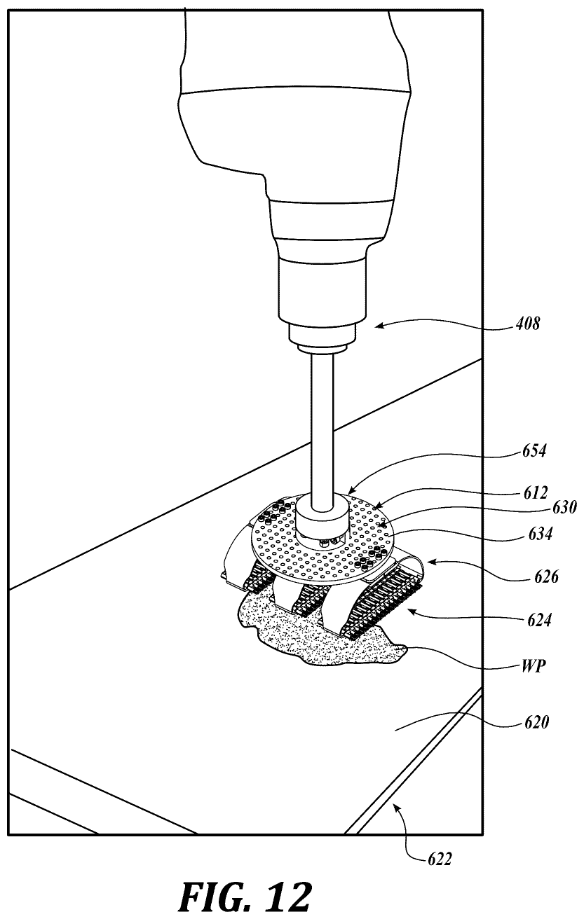

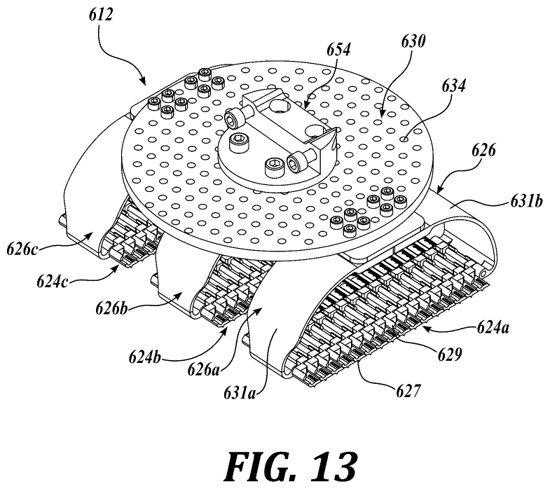

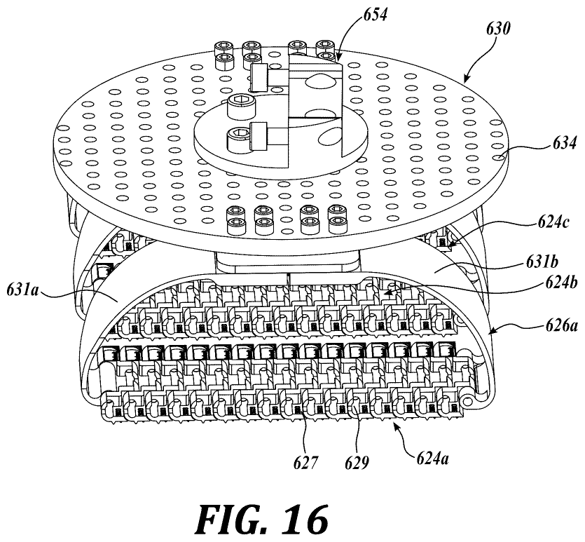

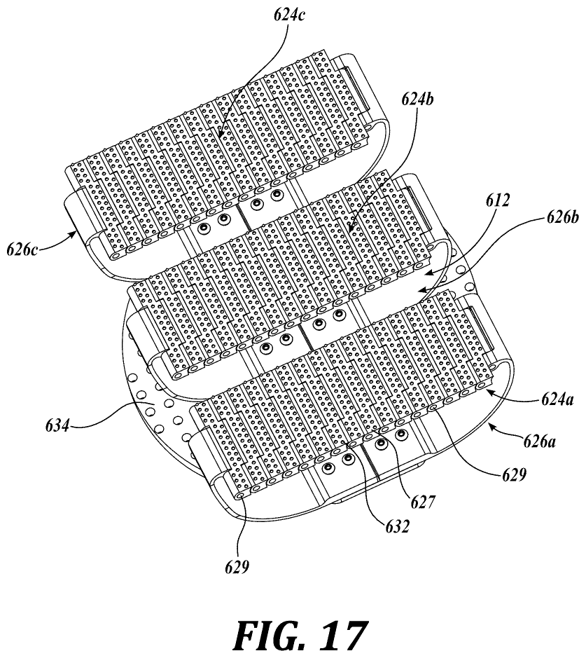

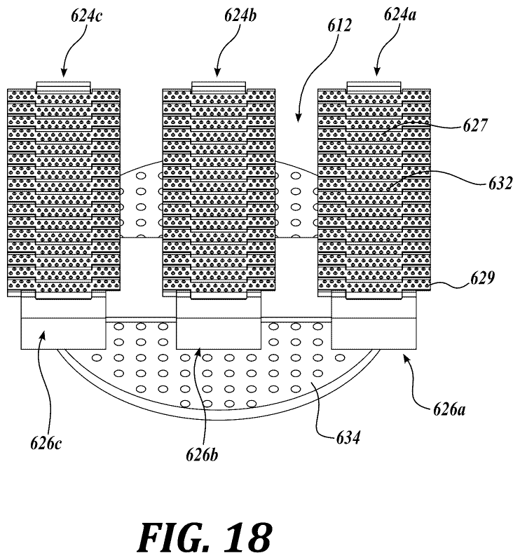

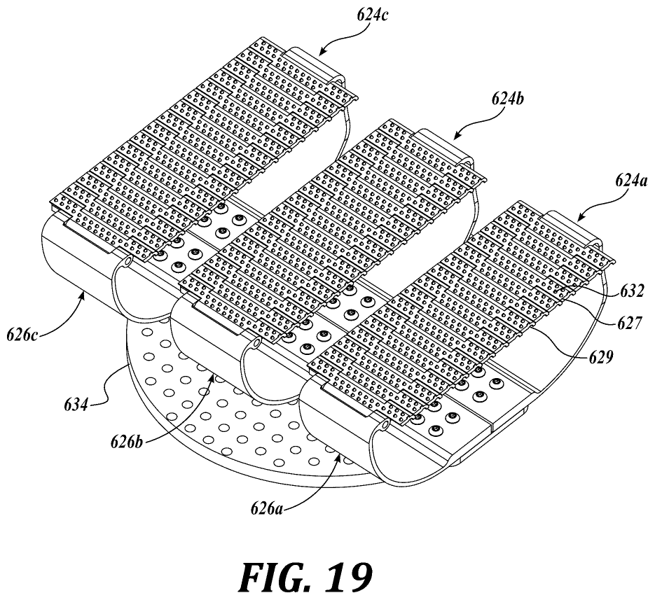

An alternative example of an end effector 612 that may be used with the automated line loading system and method described herein, or other suitable applications, will now be described with reference to FIGS. 12-19. Like the end effector 512 described above, the exemplary end effector 612 depicted in FIGS. 12-19 is configured to move a workpiece WP to a desired location and/or orientation on a conveying surface of a conveyor in a gentle manner without substantially lifting the workpiece. As will be described in more detail below, the end effector 612 is configured to resiliently, compliantly, and frictionally engage with a workpiece WP, wherein frictional forces between the end effector 612 and the workpiece WP are sufficient to overcome frictional forces between a conveying surface 620 of a conveyor 622 and the workpiece WP, as shown in FIG. 12. In that manner, the end effector 612 can facilitate movement of the workpiece WP along the conveying surface 620 without the need to lift the workpiece WP.

In the depicted example, the end effector 612 includes a gripping member assembly having a plurality of gripping members 624 each configured to compliantly, and frictionally engage a workpiece WP, a corresponding number of biasing assemblies 626 configured to resiliently urge portions of the corresponding gripping member 624 into engagement with the workpiece WP and enhance frictional engagement, and a base mounting assembly 630 configured to oppose a biasing force of the end effector 612 and secure the end effector to a workpiece organizing component for being moved relative to the conveying surface 620. As will become appreciated, using more than one gripping member 624 and corresponding biasing assembly 626 can enable the end effector 612 to more specifically conform to an outer surface profile of a workpiece. Further, as with the end effector 512, aspects of each of the gripping members 624 and biasing assemblies 626 define a friction assembly configured to define a friction interface between each gripping member and a workpiece such that when a downward force is applied to the gripping members 624, the gripping members may be moved at least one of horizontally and rotationally to adjust at least one of a location and orientation of the workpiece on a surface without substantially lifting the workpiece.

Exemplary aspects of the plurality of gripping members 624 will now be described. In the example shown, the end effector 612 includes first, second, and third gripping members 624a, 624b, and 624c (herein sometimes simply referred to as “gripping members 624” or “gripping member 624”). However, it should be appreciated that any suitable number of gripping members 624 may instead be used. Moreover, in the depicted example, the first, second, and third gripping members 624a, 624b, and 624c are substantially identical, and therefore, only the first gripping member 624a will be described in detail. However, in some examples, the design of each gripping member may vary to optimally accommodate non-lifting movement of a workpiece.

As noted above, the gripping members 624 are configured to resiliently, compliantly, and frictionally engage a workpiece WP. In that regard, the first gripping member 624a includes a body 625 having a size, shape, and composition to resiliently, compliantly, and frictionally engage at least a portion of an outer surface of a workpiece.

In some examples, the overall shape or outline of the body 625 of the gripping member 624 may be configured to substantially match a shape or outline of a portion of the workpieces to be moved. For example, if the end effector 612 was configured for use with chicken breast fillets, the body 625 of the first gripping member 624a may have a more or less elongated shape to better match a portion of the chicken breast fillet (such as the rounded end or the pointed end).

In the depicted example, the body 625 of the first gripping member 624a is configured as a plurality of pivotally interconnected, substantially rectangular, semi-rigid or rigid body members 627 defining an overall rectangular body shape. The body members 627 each have a length that extends substantially transversely to the length of the gripping member body 625.

A connecting rod 629 extends along the length of each pair of adjacent body members 627 on an interior side of the body members 627. The connecting rod 629 is received within aligned openings of adjacent body members 627 defined on the interior side of the body members 627. The body members 627 are moveable relative to one another by pivoting about the axis of the corresponding connecting rod 629. In that manner, the body 625 can change in overall shape to substantially conform to at least a portion of an outer surface of a workpiece. At the same time, the body 625 can return to a substantially original or non-deformed shape for thereafter engaging and conforming to the shape of a next workpiece to be moved.

The outer side of the body members 627, which defines a contact surface 628 of the body 625, is substantially flat when the body 625 is in a non-deformed position. In that regard, the outer side of the body members 627 are substantially flush when the body 625 is in a non-deformed position. In some examples, the body 625 may be made from the same or similar components as a plastic modular conveyor belt. The components of the body 625, including the body members 627 and connecting rods 629, may be made from a suitable food grade material(s), such as plastic.

The outer contact surface 628 of the body 625 is configured to frictionally engage a workpiece WP. In that regard, the outer contact surface 628 of the body 625 may include friction-enhancing elements. In the depicted example, the outer contact surface 628 is covered with a plurality of substantially uniformly distributed protrusions 632. In some examples, the friction-enhancing elements may be defined by other types of features, such as a plurality of recesses, holes, or the like defined in the body 525. In any event, the friction-enhancing elements, such as the protrusions 632 are configured to frictionally engage with the workpiece WP and increase the overall frictional forces between the workpiece WP and the contact surface 628.

In that regard, the protrusions 632 have an individual size and shape configured to collectively help define a frictional interference between the gripping member and the workpiece. The friction interference is sufficient to enable the end effector 612 to adjust at least one of a location and orientation of the workpiece on the surface without substantially lifting the workpiece.

In the example shown, the protrusions 632 are dome-shaped or at least somewhat rounded in overall shape to facilitate gripping against the outer surface of the workpiece WP without piercing or otherwise damaging the workpiece WP. In other examples, where a greater frictional force between the contact surface 628 and the workpiece WP is needed, and/or where surface damage to the workpiece WP is not an issue, the raised protrusions 632 may be configured as sharper, more pointed protrusions.

In any event, the protrusions 632 are configured to overcome frictional forces between the conveying surface 620 and the workpiece WP to move the workpiece relative to the conveying surface 620 without substantially lifting the workpiece. The downward force of the workpiece organizing component causes the protrusions 632 to frictionally engage the workpiece. In that regard, a sufficient downward force is applied to the workpiece WP via the workpiece organizing component to cause the protrusions 632 to meet at least minimum frictional load requirements for moving the workpiece. The downward force of the workpiece organizing component may be controllable or otherwise limited (e.g., the workpiece organizing component is only moved downwardly to a certain height relative to the conveying surface 620) to substantially prevent damage to the workpiece WP, flattening of the workpiece WP, etc.

In the examples described herein, the contact surface 628 is further configured to prevent adherence to the workpiece WP once the workpiece WP has been arranged in a preferred location, orientation, etc. In other words, after the workpiece WP has been moved to its preferred location, orientation, etc., the end effector 612 can be disengaged from the workpiece and moved upwardly toward a retracted position without substantially affecting the workpiece location, orientation, etc. In that regard, the raised protrusions 632 are sufficiently shaped and sized to substantially avoid piercing the workpiece WP, which might otherwise cause substantial lifting of the workpiece WP off the conveying surface 620 when the end effector 612 is retracted. Further, the material of the gripping member 624 may be selected to substantially prevent an adhesive effect between the contact surface 628 and the workpiece WP. Thus, as can be appreciated, movement of the workpiece WP relative to the conveying surface 620 can be achieved with substantially no lifting of the workpiece WP.

The body 625 of each gripping member 624 is resiliently urged into engagement with a workpiece and thereafter urged back into its original, substantially non-deformed position, such as by a corresponding biasing assembly 626. For instance, in the example shown, the first gripping member 624a, second gripping member 624b, and third gripping member 624c are biased toward a deformed or non-deformed shape by first, second, and third biasing assemblies 626a, 626b, and 626c, respectively (herein sometimes simply referred to as “biasing assemblies 626” or “biasing assembly 626”). In the depicted example, the first, second, and third biasing assemblies 626a, 626b, and 626c are substantially identical; and therefore, only the first biasing assembly 626a will be described in detail. However, in some examples, the design of each biasing assembly may vary to optimally accommodate non-lifting movement of a workpiece.

The first biasing assembly 626a is generally configured as a compliant mechanism assembly that can achieve motion and force transmission through elastic deformation. For instance, the first biasing assembly 626a includes at least one flexible structure that can elastically deform to urge the gripping member body 625 toward a deformed or non-deformed shape.

In the depicted example, the first biasing assembly 626a includes first and second compliant flexures 631a and 631b extending between first and second ends of the gripping member body 625 and the base mounting assembly 630, respectively. In the example shown, each of the compliant flexures 631a and 631b (or simply “compliant flexure 631”) is a monolithic (single-piece) or jointless structure having a curvature that supports compliant connectivity between the first and second ends of the gripping member body 625 and the base mounting assembly 630. For example, the compliant flexure 631 may be an elongated, flattened, thin piece of material that is formed into a generally open C-shape.

A first end of the first compliant flexure 631a is pivotally connected to an end-most connecting rod 629 located at the first end of the gripping member body 625. In that regard, the first end of the first compliant flexure 631a includes at least one opening configured to receive the end-most connecting rod 629. The end-most connecting rod 629 is also secured within an aligned opening(s) of the end-most body member 627 at the first end of the gripping member body 625. As such, the first end of the first compliant flexure 631a may pivot about the axis of the end-most connecting rod 629 relative to the gripping member body 625 to support deformation of the gripping member body 625. A first end of the second compliant flexure 631b is pivotally connected to an end-most connecting rod 629 located at the second end of the gripping member body 625 in a substantially identical manner.

The first and second compliant flexures 631a and 631b extend generally outwardly from the first and second ends of the gripping member body 625, and then each flexure curves upwardly and inwardly toward the base mounting assembly 630 located generally above the gripping member 624. A second end of each of the first and second compliant flexures 631a and 631b is fixedly connected to a base plate 634 of the base mounting assembly 630. With the second end of the compliant flexure 631 fixed relative to the base mounting assembly 630, the base mounting assembly 630 can oppose a biasing force of the compliant flexure 631 when the flexure elastically deforms to accommodate movement of the gripping member body 625.

The base mounting assembly 630, base plate 634 may be substantially similar to the base mounting assembly 530 and base plate 534 described above with the exception of any differences or details discussed. Moreover, the end effector 612 may further include a workpiece organizing component mounting assembly 654 that is substantially similar to or identical to the workpiece organizing component mounting assembly 554 described above. Thus, detailed aspects of the base mounting assembly 630 and the workpiece organizing component mounting assembly 654 will not be provided.

The biasing force of the compliant flexures 631a and 631b urge the respective end portions of the gripping member 624 into engagement with the workpiece WP when a downward force is supplied by the workpiece organizing component (e.g., a prime mover, such as prime mover 408). Upon engagement with the workpiece WP, the gripping member 624 moves upwards towards the base plate 634 in response to the reactive force of the workpiece WP, deforming the compliant flexures 631a and 631b. At the same time, the biasing force of the deformed compliant flexures 631a and 631b urges corresponding end portions of the gripping member 624 toward the workpiece WP. As such, outer ends of the gripping member 624, as may be generally defined near the perimeter of the workpiece WP, substantially envelop outer portions of the workpiece. Moreover, the body members 627 of the gripping member 624 pivot about the connecting rods 629 and move relative to one another, allowing the gripping member body 625 to substantially conform to the outer surface profile (e.g., dome-like curvature) of the workpiece WP.

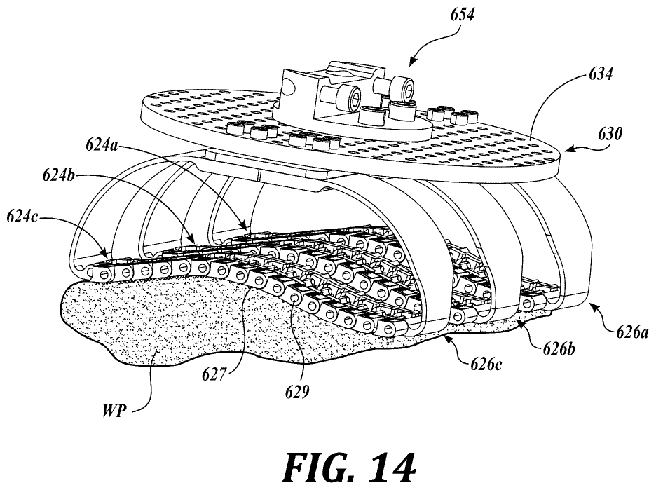

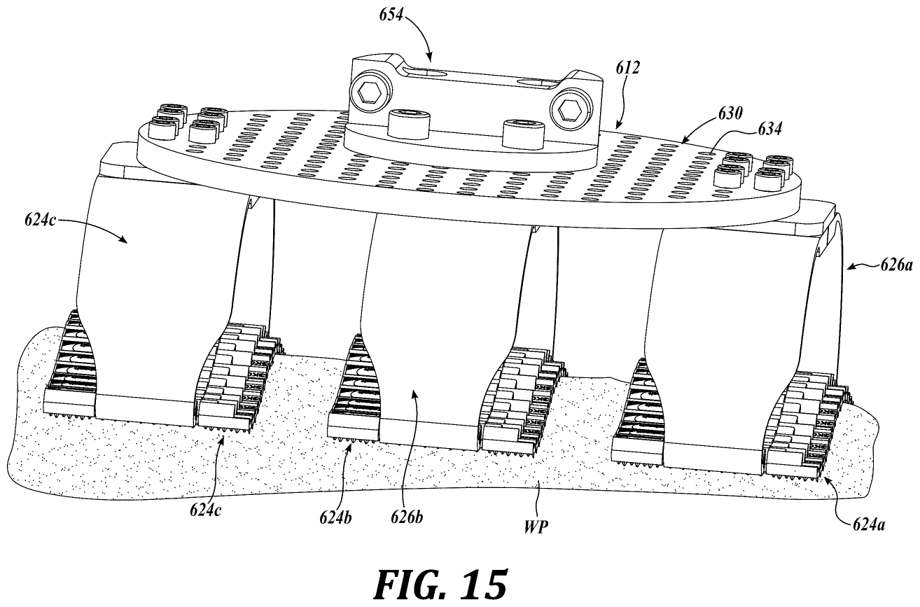

In effect, the compliant gripping member 624 substantially conforms to the outer surface profile of the workpiece WP, as shown in FIGS. 14 and 15. By substantially conforming to or enveloping a portion of the workpiece WP in this manner, the contact surface area of the gripping member 624 with the workpiece WP, and thus, the frictional interface therebetween can be maximized. Maximizing the frictional interface helps facilitate optimized manipulation of the workpiece WP into the preferred location and/or orientation on the conveying surface 620.

The frictional interface between the gripping member 624 and the workpiece WP may be defined at least in part from the biasing force of the compliant flexures 631 and/or the compliance of the gripping member 624 to the workpiece WP. In that regard, either or both of the biasing force of the compliant flexures 631 and the compliance of the gripping member 624 to the workpiece WP may be adjusted to change the frictional interface between the gripping member 624 and the workpiece WP.

For instance, the biasing force of the compliant flexures 631 may be adjusted by moving the location at which the second end of the compliant flexures 631 connect to the base plate 634. Specifically, the second ends of the compliant flexures 631 may be moved toward one another to increase the biasing force of the compliant flexures 631 (e.g., to increase the bend or deformation in the compliant flexures 631). By contrast, the second ends of the compliant flexures 631 may be moved away from one another to decrease the biasing force of the compliant flexures 631 (e.g., to decrease the bend or deformation in the compliant flexures 631). In that regard, in some examples, the biasing assembly 626 may be adjustable to designate a desired biasing force of the gripping member 624. For instance, and as shown, the base plate 634 may include a plurality of openings in which a fastener may be received for securing the second ends of the compliant flexures 631 in one of a plurality of positions.

The compliance of the gripping member 624 may also or instead be adjusted to change the frictional interface between the gripping member 624 and the workpiece WP. For instance, a tension of the gripping member 624 can be adjusted by removing or adding body members 627 in the gripping member body 625 to shorten or lengthen the body 625. Shortening the gripping member body 625 will result in a higher tension gripping member 624, and lengthening the body 625 will result in a lower tension gripping member 624. A higher tension gripping member 624 will be less conformable to the shape of the workpiece, but it may enhance the frictional interface between the gripping member 624 and the workpiece WP. By contrast, a lower tension gripping member 624 will be more conformable to the shape of the workpiece, which can increase the frictional surface area interface therebetween.

With each of the gripping members 624a, 624b, and 624c resiliently, compliantly, and frictionally engaged with a workpiece WP, as described above, the end effector 612 may be manipulated by the workpiece organizing component (e.g. a prime mover such as prime mover 408) to move the workpiece WP into a preferred location, orientation, etc. For instance, after a sufficient downward force has been applied to the end effector 612 by a prime mover, a rotational force may be applied to the end effector 612 to manipulate the orientation of the workpiece WP to a preferred orientation. In addition, or in the alternative, a lateral or horizontal force may be applied to the end effector 612 to move the workpiece WP laterally/horizontally to a preferred location on the conveying surface 620.

After the workpiece WP has been moved to its preferred location, orientation, etc., the end effector 612 is moved upwardly toward a retracted position by the prime mover to disengage the workpiece. Upon disengaging the workpiece WP, the compliant flexures 631 move towards a non-deformed state, pulling generally outwardly on the first and second ends of the gripping member body 625 and urging the gripping member 524 back towards the original, substantially flat shape it possessed prior to deformation (see FIG. 7). In that regard, the gripping member 624, having a body 625 defined by a plurality of interconnected and moveable body members 627, may be considered a compliant assembly as it may return to its original, non-workpiece-conforming shape. In some examples, the body 625 defined by a plurality of interconnected and moveable body members 627 may be configured as a resilient assembly to help or otherwise define the biasing force of the gripping member 624.

With the gripping member 624 substantially back to its original form, the end effector 512 is ready for engagement with and substantial shape conformance with another workpiece. In that regard, the resilient, compliant gripping member 524 is configured for individualized, repeated frictional engagement with workpieces WP moving along the conveying surface 520.

As noted above, the end effector 612 is configured with a plurality of gripping members 624 such that each of the gripping members may engage and substantially conform to a certain area of a workpiece. For example, if the end effector 612 was configured for use with chicken breast fillets, as shown in FIG. 15, the first gripping member 624a may be configured to engage a pointed end portion of the chicken breast fillet, and the second and third gripping members 624b and 624c may be configured to engage a rounded end portion of the chicken breast fillet. In that regard, the gripping members 624 may be specifically positioned on the base plate 634 and/or relative to each other to optimally engage a portion of a workpiece. In some examples, the plurality of gripping members 624 may be arranged such that one or more of the gripping members engages a first workpiece, and one or more of the gripping members engages a second workpiece.

As shown in the depicted example, the second and third gripping members 624b and 624c are located adjacent to one another without much of a gap therebetween, while a more significant gap is defined between the second gripping member 624b and the first gripping member 624a. Of course, other spacing arrangements of the gripping members 624 may instead be used. The gripping members 624 are also shown as being oriented substantially parallel to one another (e.g., with substantially parallel elongated gripping member body axes). The gripping members 624 may additionally or instead be oriented such that the elongated gripping member body axes are at an angle relative to one another. Further, each of the gripping members 624a and corresponding biasing assemblies 626 may have a preferred tension and biasing force, respectively, as discussed above.

In any event, the plurality of gripping members 624 may be configured to collectively substantially conform to an outer profile of a workpiece and resiliently and frictionally engage a workpiece for carrying out non-lifting movement of the workpiece. In that regard, using more than one gripping member 624 and corresponding biasing assembly 626 can enable the end effector 612 to more specifically conform to an outer surface profile of a workpiece. Further, using more than one gripping member 624 and corresponding biasing assembly 626 can enable the end effector 612 to be more specifically configured for use with a certain type or configuration of workpiece.

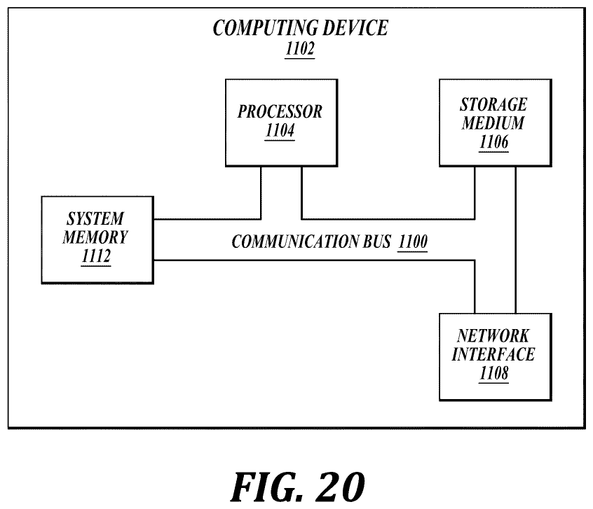

FIG. 20 is a block diagram that illustrates aspects of an exemplary computing device 1100 appropriate for use as a computing device of the present disclosure. While multiple different types of computing devices were discussed above, the exemplary computing device 1100 describes various elements that are common to many different types of computing devices. While FIG. 20 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 1100 may be any one of any number of currently available or yet to be developed devices.

In its most basic configuration, the computing device 1100 includes at least one processor 1102 and a system memory 1110 connected by a communication bus 1108. Depending on the exact configuration and type of device, the system memory 1110 may be volatile or nonvolatile memory, such as read only memory (“ROM”), random access memory (“RAM”), EEPROM, flash memory, or similar memory technology. Those of ordinary skill in the art and others will recognize that system memory 1110 typically stores data and/or program modules that are immediately accessible to and/or currently being operated on by the processor 1102. In this regard, the processor 1102 may serve as a computational center of the computing device 1100 by supporting the execution of instructions.

As further illustrated in FIG. 20, the computing device 1100 may include a network interface 1106 comprising one or more components for communicating with other devices over a network. Examples of the present disclosure may access basic services that utilize the network interface 1106 to perform communications using common network protocols. The network interface 1106 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 1106 illustrated in FIG. 20 may represent one or more wireless interfaces or physical communication interfaces described and illustrated above with respect to particular components of the computing device 1100.

In the example depicted in FIG. 20, the computing device 1100 also includes a storage medium 1104. However, services may be accessed using a computing device that does not include means for persisting data to a local storage medium. Therefore, the storage medium 1104 depicted in FIG. 20 is represented with a dashed line to indicate that the storage medium 1104 is optional. In any event, the storage medium 1104 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 1102, system memory 1110, communication bus 1108, storage medium 1104, and network interface 1106 are known and commercially available. For ease of illustration and because it is not important for an understanding of the claimed subject matter, FIG. 20 does not show some of the typical components of many computing devices. In this regard, the computing device 1100 may include input devices, such as a keyboard, keypad, mouse, microphone, touch input device, touch screen, tablet, and/or the like. Such input devices may be coupled to the computing device 1100 by wired or wireless connections including RF, infrared, serial, parallel, Bluetooth, Bluetooth low energy, USB, or other suitable connections protocols using wireless or physical connections. Similarly, the computing device 1100 may also include output devices such as a display, speakers, printer, etc. Since these devices are well known in the art, they are not illustrated or described further herein.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the present disclosure, references to “food,” “food products,” “food pieces,” “food items,” “pieces,” “portions,” etc., are used interchangeably and are meant to include all manner of foods. Such foods may include meat, fish, poultry, plant-based products, fruits, vegetables, nuts, or other types of foods. Also, the automated line loading system and method disclosed herein is directed to raw food products, as well as partially and/or fully processed or cooked food products.

Further, automated line loading systems and methods disclosed herein, though sometimes described with specific applicability to food products or food items, may also be used outside of the food area. Accordingly, the present disclosure may reference “workpieces,” “products”, “components”, “samples”, etc., which terms are synonymous with each other. It is to be understood that references to “workpieces,” “products”, “components”, “samples”, etc., also include food, food products, food pieces, food items, etc. Moreover, references to “food”, “food products”, “food pieces”, “food items”, “pieces”, “portions”, etc., also include “workpieces,” “products”, “components”, “samples”, etc.

References in the specification to “one example,” “an example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIGS. Additionally, the inclusion of a structural or method feature in a particular FIG. is not meant to imply that such feature is required in all examples and, in some examples, it may not be included or may be combined with other features.

The present application may include modifiers such as the words “generally,” “approximately,” “about”, or “substantially.” These terms are meant to serve as modifiers to indicate that, for instance, the “dimension,” “shape,” “temperature,” “time,” or other physical parameter in question need not be exact, but may vary as long as the function that is required to be performed can be carried out.

As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Headings of sections provided in this patent application and the title of this patent application are for convenience only and are not to be taken as limiting the disclosure in any way.

While preferred examples of the present invention have been shown and described herein, it will be apparent to those skilled in the art that such examples are provided by way of example only. Numerous variations, changes, and substitutions will now occur to those skilled in the art without departing from the invention. Various alternatives to the examples of the invention described herein may be employed in practicing the invention. It is intended that the following claims define the scope of the invention and that methods and structures within the scope of these claims and their equivalents be covered.

The embodiments of the invention in which an exclusive property or privilege is claimed are defined as follows:

1. An end effector for a workpiece organization assembly, comprising:
a gripping member assembly having a gripping member configured to compliantly engage a workpiece;
a biasing assembly configured to resiliently urge the gripping member into engagement with a workpiece;
a friction assembly configured to define a friction interface between the gripping member and a workpiece such that when a downward force is applied to the gripping member, the gripping member may be moved at least one of horizontally and rotationally to adjust at least one of a location and orientation of the workpiece on a surface without lifting the workpiece; and
a base mounting assembly configured to secure the end effector to a workpiece organizing component configured to move in multiple directions.

2. The end effector of claim 1, wherein the friction assembly is defined at least in part by a plurality of friction-enhancing elements defined on a contact surface of the gripping member.

3. The end effector of claim 1, wherein the friction assembly is defined at least in part by a plurality of protrusions defined on a contact surface of the gripping member.

4. The end effector of claim 3, wherein the protrusions have a size and shape configured to help collectively define a friction interference between the gripping member and the workpiece such that the gripping member may be moved at least one of horizontally and rotationally to adjust at least one of a location and orientation of the workpiece on the surface without lifting the workpiece.

5. The end effector of claim 3, wherein the protrusions are configured to frictionally engage a workpiece without piercing the workpiece, thus allowing for movement of the workpiece without adhesion to the gripping member.

6. The end effector of claim 1, wherein the biasing assembly is configured to resiliently urge the gripping member into at least partial substantial shape conformance with an outer profile of a workpiece when a downward force is applied to the gripping member.

7. The end effector of claim 1, wherein the friction assembly is defined at least in part by the biasing assembly.

8. The end effector of claim 1, wherein the biasing assembly includes a plurality of compression springs disposed between the gripping member and a base plate of the base mounting assembly, the base plate configured to oppose the biasing force of the compression springs.

9. The end effector of claim 8, wherein the plurality of compression springs are coaxially received on a corresponding number of fasteners extending through the base plate and the gripping member, the fasteners securing the base plate and the gripping member together in a spaced, substantially parallel relationship.

10. The end effector of claim 1, wherein gripping member assembly includes a plurality of gripping members each configured to compliantly engage at least a portion of a workpiece.

11. The end effector of claim 10, wherein each of the plurality of gripping members includes a gripping member body having a plurality of pivotally interconnected body members.

12. The end effector of claim 10, wherein the biasing assembly includes a plurality of compliant flexures corresponding in number to the plurality of gripping members, each compliant flexure configured to resiliently urge the corresponding gripping member into engagement with at least a portion of a workpiece.

13. An automated infeed system, comprising:
a primary organization assembly configured to perform a primary workpiece organization to an aggregated supply of workpieces;
an organization assessment assembly having at least one sensor configured to capture sensor data regarding the primary workpiece organization; and
a secondary organization assembly configured to perform a secondary workpiece organization based on the sensor data regarding the primary workpiece organization, the secondary organization assembly comprising:
a workpiece organization component assembly configured for adjusting a position of a workpiece, the workpiece organization component assembly comprising:
at least one workpiece organizing component configured to move in multiple directions;
an end effector moveable by the at least one workpiece organizing component and configured to engage and slide a workpiece along a surface of a movement assembly without lifting the workpiece; and
a workpiece organization component controller configured for controlling movement of the workpiece organization component assembly.

14. The automated infeed system of claim 13, wherein the workpiece organizing component is an industrial robot.

15. The automated infeed system of claim 13, wherein the workpiece organizing component is a prime mover configured as a linear actuator system having linear actuator assemblies configured to move the end effector in at least x- y-, z-, and theta axis directions.

16. The automated infeed system of claim 13, wherein the end effector comprises:
a gripping member assembly having a gripping member configured to compliantly engage a workpiece;
a biasing assembly configured to resiliently urge the gripping member into engagement with a workpiece;
a friction assembly configured to define a friction interface between the gripping member and a workpiece such that when a downward force is applied to the gripping member, the gripping member may be moved at least one of horizontally and rotationally to adjust at least one of a location and orientation of the workpiece on a surface without lifting the workpiece; and
a base mounting assembly configured to secure the end effector to a workpiece organizing component configured to move in multiple directions.

17. The automated infeed system of claim 16, wherein the friction assembly is defined at least in part by a plurality of protrusions defined on a contact surface of a resilient gripping member of the end effector.

18. The automated infeed system of claim 17, wherein the protrusions have a size and shape configured to collectively define a friction interference between the resilient gripping member and the workpiece such that the gripping member may be moved at least one of horizontally and rotationally to adjust at least one of a location and orientation of the workpiece on the surface without lifting the workpiece.

19. The automated infeed system of claim 17, wherein the protrusions are configured to frictionally engage a workpiece without piercing the workpiece, thus allowing for movement of the workpiece without adhesion to the resilient gripping member.

20. An end effector for a workpiece organization assembly, comprising:
a gripping member assembly having a gripping member configured to compliantly engage a workpiece;
a biasing assembly configured to resiliently urge the gripping member into engagement with a workpiece; and
a base mounting assembly configured to secure the end effector to a workpiece organizing component configured to move in multiple directions,
wherein when a downward force is applied to the gripping member, the gripping member may be moved at least one of horizontally and rotationally to adjust at least one of a location and orientation of the workpiece on a surface without lifting the workpiece.
